(19) United States
(12) Patent Application Publication
(10) Pub. No.: US 2021/0004791 A1
(43) Pub. Date: Jan. 7, 2021

(54) GUARANTEEING SERVER AND METHOD FOR TRANSACTION ON BLOCKCHAIN

(71) Applicant: STAR BIT Innovation Co., Ltd., New Taipei City (TW)

(72) Inventors: Bo-Ting LIU, New Taipei City (TW); Yao-Hao CHEN, New Taipei City (TW); Ta-Wei MIN, New Taipei City (TW); Chi-Liang CHENG, New Taipei City (TW); Wan-Wei TENG, New Taipei City (TW)

(21) Appl. No.: 16/599,994

(22) Filed: Oct. 11, 2019

(30) Foreign Application Priority Data
Jul. 5, 2019 (TW) 108123867

(51) Int. Cl. G06Q 20/36; H04L 9/06; G06Q 20/06

(52) U.S. Cl. CPC G06Q 20/3678; G06Q 20/3676; G06Q 20/0655; H04L 9/0637

(57) ABSTRACT

A guaranteeing server and a guaranteeing method for transaction on blockchain are disclosed. The guaranteeing server is coupled to a blockchain network and comprises a memory unit and one or more processing units. The memory unit stores a plurality of instructions and the processing units execute the instructions to perform steps of: receiving a transaction data from a user, wherein the transaction data includes a wallet data including a wallet address data and a user's signature data; checking whether a cryptocurrency balance associated with the wallet address data on the blockchain network is sufficient to execute the transaction; when the cryptocurrency balance is sufficient to execute the transaction, transmitting the transaction data to the blockchain network for performing a blockchain operation; and transmitting a transaction guarantee information corresponding to the transaction data to an opposing party of the transaction.

### CROSS REFERENCE TO RELATED APPLICATIONS

This Non-provisional application claims priority under 35 U.S.C. § 119(a) on Patent Application No(s). 108123867 filed in Taiwan, Republic of China on Jul. 5, 2019, the entire contents of which are hereby incorporated by reference.

### BACKGROUND

### Technology Field

This present disclosure relates to a guaranteeing method and server for a transaction and, in particular, to a guaranteeing method and a guaranteeing server for a transaction on blockchain.

### Description of Related Art

Blockchain is a decentralized digital book with a consensus algorithm, and the most widely used blockchain technology is cryptocurrency. The cryptocurrency based on blockchain technology has the characteristics of decentralization and is not regulated by central banks of different countries. At the same time, the records of cryptocurrency transactions are in principle permanent and irreversible, and can be verified and traced. For example, the traditional decentralized transaction process is initiated by a party to the transaction to sign with the user's private key, and to submit the transaction content and its digital signature to the blockchain, and the submitted data can be verified and recorded by each node. To ensure the security, the opposing party of the transaction usually does not just wait for one confirmation to conclude that the transaction has been completed. In general, the opposing party of the transaction will wait for at least 6 confirmations before the transaction is considered complete. This often takes from ten minutes to several hours. However, the cash-based transactions can take only about 3 minutes to complete, and the use of credit cards or other non-centralized virtual currency can finish the transactions within about 0.5 minutes to 1 minute. Therefore, the traditional blockchain technology needs long waiting time in cryptocurrency transactions, which cannot satisfy the parties (ordinary people) in the transactions.

However, cryptocurrencies based on blockchain technology still have other security flaws. For example, if a malicious user has a higher hash rate (e.g. 51%), he can launch a double spend attack to destroy the unmodifiability of the original transaction record, so that the transaction existing in the non-deletable block is erased and the cryptocurrency that has been “spent” can be used again. Even if, for example, the Ethereum platform using Turing's complete language Solidity, malicious users can still pay a higher “Gas” for conducting a double spend attack, so that the later transactions are record prior to the earlier transactions. Then, the earlier transactions will be determined as authentication failure because the node finds that there is not enough cryptocurrency balance when confirming the corresponding wallet address, so that the opposing party of the earlier transaction cannot obtain the consideration of the transaction.

Therefore, it is desired to provide a transaction method for cryptocurrency transactions on blockchain that can prevent the double spend attack from malicious users and can allow the opposing party of the transaction to complete the transaction without spending a lot of waiting time.

### SUMMARY

An objective of this disclosure is to provide a guaranteeing server and guaranteeing method for a transaction on blockchain. The guaranteeing server can check whether a cryptocurrency balance of the user is sufficient to execute the transaction before transmitting the transaction to the blockchain network for calculation, thereby preventing the double spend attack from malicious users. In addition, the guaranteeing server can provide the authentication and guaranteeing for the transactions, so that the opposing party (e.g. the store) can be acknowledged whether the transaction is guaranteed or not within a short time, thereby guaranteeing the validity of the transaction and reducing the waiting time.

This disclosure provides a guaranteeing server for a transaction on blockchain. The guaranteeing server is coupled to a blockchain network and comprises a memory unit and one or more processing units. The memory unit stores a plurality of instructions, and the processing units executes the instructions to perform steps of: receiving a transaction data from a user, wherein the transaction data comprises a wallet data including a wallet address data and a user's signature data; checking whether a cryptocurrency balance associated with the wallet address data on the blockchain network is sufficient to execute the transaction; when the cryptocurrency balance is sufficient to execute the transaction, transmitting the transaction data to the blockchain network for performing a blockchain operation; and transmitting a transaction guarantee information corresponding to the transaction data to an opposing party of the transaction.

In addition, this disclosure also provides a guaranteeing method for a transaction on blockchain, which comprises steps of: receiving a transaction data from a user by a guaranteeing server, wherein the transaction data comprises a wallet data including a wallet address data and a user's signature data; the guaranteeing server checking whether a cryptocurrency balance associated with the wallet address data on the blockchain network is sufficient to execute the transaction; when the cryptocurrency balance is sufficient to execute the transaction, the guaranteeing server transmitting the transaction data to the blockchain network for performing a blockchain operation; and the guaranteeing server transmitting a transaction guarantee information corresponding to the transaction data to an opposing party of the transaction.

In one embodiment, the user's signature data is a digital signature of the user corresponding to the wallet address data.

In one embodiment, the transaction data further comprises a transaction content and an opposing party data.

In one embodiment, when the cryptocurrency balance is not enough to execute the transaction, the guaranteeing server sends a transaction fail information to the user and does not transmit the transaction data to the blockchain network.

In one embodiment, the user uploads the wallet data and a deposit data to the blockchain network for increasing the cryptocurrency balance associated with the wallet address data through the blockchain network.

In one embodiment, the opposing party uploads the wallet data and a deposit data to the blockchain network for increasing the cryptocurrency balance associated with the wallet address data through the blockchain network.

In one embodiment, the user sends another wallet data, a deposit data and the wallet data to the guaranteeing server for increasing the cryptocurrency balance associated with the wallet address data through the guaranteeing server.

In one embodiment, after finishing the blockchain operation, the guaranteeing server further returns a transaction success conformation information to the user and/or the opposing party.

In one embodiment, after finishing the blockchain operation, the guaranteeing server further summarizes the cryptocurrency balance associated with the wallet address data.

As mentioned above, in the guaranteeing server and guaranteeing method for a transaction on blockchain of this disclosure, the guaranteeing server can check whether a cryptocurrency balance of the user is sufficient to execute the transaction before transmitting the transaction to the blockchain network for operation, thereby preventing the double spend attack from malicious users. In addition, after confirming that the cryptocurrency balance of the user is sufficient to execute the transaction, the guaranteeing server can transmit the transaction guarantee information to the opposing party of the transaction. Based on the authentication and guaranteeing from the guaranteeing server, the opposing party can be acknowledged whether the transaction is guaranteed by the guaranteeing server or not within a short time, thereby guaranteeing the validity of the transaction and reducing the waiting time.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing the guaranteeing server for transactions on blockchain according to an embodiment of this disclosure;

FIG. 2 is a functional block diagram of the guaranteeing server of FIG. 1; and

FIG. 3 is a flow chart of a guaranteeing method for transactions on blockchain according to an embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

Unless otherwise defined, all technical and scientific terms used herein have the same meanings the same as the ordinary meanings realized by those of ordinary skill in the art. It is understood that the terminology used herein is for the purpose of description the particular embodiments and is not to limit the scope of the disclosure.

It is to be noted that all directional indications (such as up, down, left, right, front, rear and the like) in the embodiments of the present disclosure are only used for explaining the relative positional relationship, circumstances during its operation, and the like, between the various components in a certain specific posture (as shown in the accompanying drawings). If the specific posture changes, the directional indication will also change accordingly.

The term “blockchain” in this disclosure refers to transaction records that are structured on a peer-to-peer (P2P) network system and encrypted and concatenated using cryptography (each record is also called a “block”). Each block contains the encrypted hash string, time stamp, and transaction data of the previous block. In addition to the above-mentioned P2P network architecture, the blockchain technology also utilizes asymmetric encryption technology (public-private key pair), distributed ledger, and consensus-based algorithmic authentication mechanism, thereby making the block content be difficult to tamper with, and become verifiable and traceable. Therefore, a currency or goods ownership transfer transaction can be carried out directly by one party, and any financial institution or a third party institution is not involved in this transaction. Thus, it has the characteristics of decentralization. This technology is commonly used in the transactions of digital currency or cryptocurrency. In a blockchain network based on a P2P network architecture, each computer (also called a “node”) in the network has the same network computing power. The network computing power may vary depending on the consensus algorithms of different blockchains.

The term “cryptocurrency” in this disclosure refers to a transaction medium that uses blockchain technology, such as asymmetric encryption, decentralized ledgers, and consensus-based algorithmic authentication mechanisms, to ensure transaction security and control transaction units. The cryptocurrency is a digital currency, which can be Bitcoin (BTC), Bitcoin cash (BCC), Ethereum (ETH), Litecoin (LTC), or Monroe (XMR), or any of other digital currencies (e.g. virtual currency).

The terms “wallet” and “wallet address” in this disclosure refer to the address corresponding to the cryptocurrency used in the transaction on the blockchain, in which the settlement of the currency (and currency balance) corresponding to the address is recorded. It uses the private key of the user or the owner to perform elliptic curve operations (e.g. secp256k1), hash function operations (e.g. SHA-256), and encoding (e.g. BASE58) to obtain a string sequence containing English letters and numbers (e.g. 0x80a956Ab640Ee8A6E336C9a954bB55f422e3Ac6e). Wallets used in blockchain transactions can be created by using, for example, asymmetric cryptography, and each wallet has its own unique pair of public and private keys. The public key of each wallet can publicly allow each node to identify the wallet (e.g. transfer cryptocurrency to the wallet address), but the private key is belong to the owner of the wallet and is used to sign the transaction. For example, each node can utilize it to verify that the transaction is true or not.

The term “smart contract” means a contract defined in digital form, which is a computer protocol written in a programming language. When used in a blockchain, such as the Ethereum blockchain, the smart contract represents a computer protocol that is delivered over the Internet and can be verified and automatically executed by computers (e.g. miners or netizens) on the blockchain. The smart contracts can be executed to carry out the verified and tracked and irreversible transaction without the existing of third parties of transaction or intermediaries. For example, when the two parties sign a smart contract in the Solidity language based on the ERC20 Token Standard and deploy it on the Ethereum blockchain (hereafter referred to as the Ethernet chain) for performing operations with the Ethereum virtual machine (EVM), the computers on the Ethernet chain will perform a corresponding action according to the contract content (e.g. withdrawal from a wallet address and transfer) when a signal related to the contract (or “event”, which can be, for example, the transfer time specified in the contract, or show that one party has delivered the goods to the other party) is shown on the computers. The deployment and execution of smart contracts on the Ethernet chain require additional computing fee, which is called “Gas”, and the “Gas” can be purchased using Ethereum. Similarly, in the Ethernet chain, the corresponding actions in the smart contract are executed in response to specific events based on a consensus-type encryption and decryption algorithm. A smart contract deployed on the Ethernet chain will also have a unique address, such as “0x03f8a79ccf94611a512b63d42f5fc3eacf59d3”.

Several exemplary embodiments will be described hereinafter.

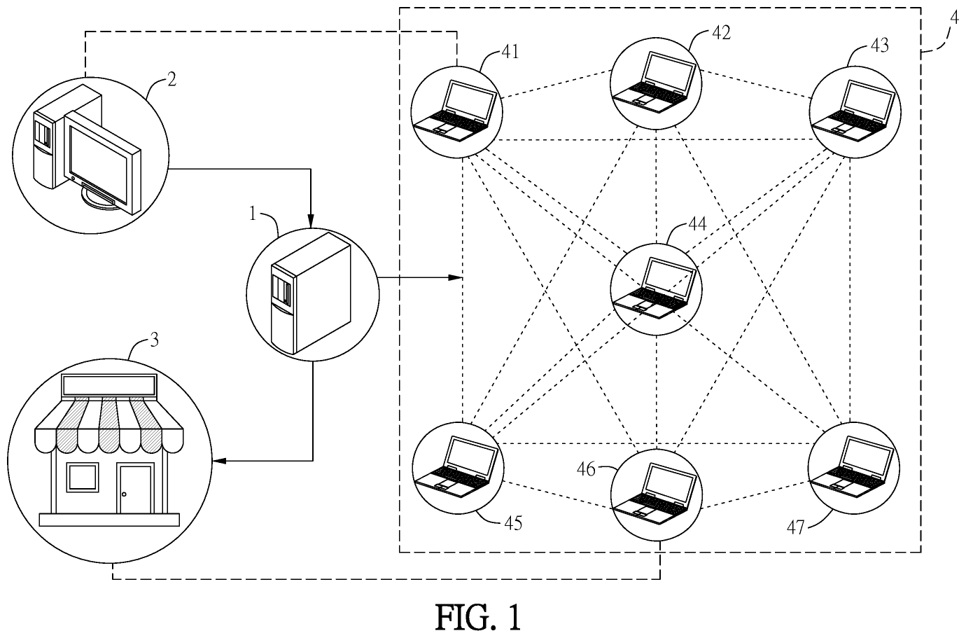

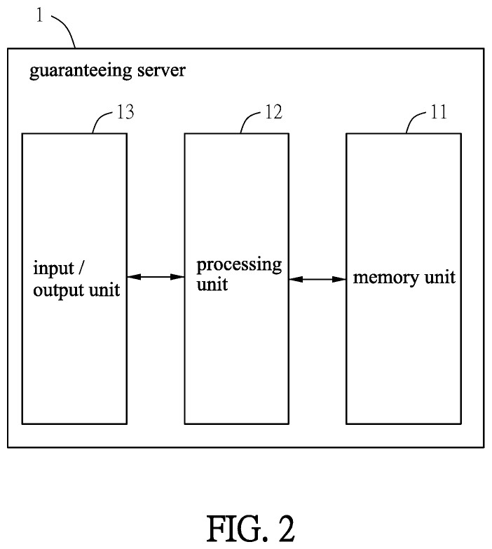

FIG. 1 is a schematic diagram showing the guaranteeing server for transactions on blockchain according to an embodiment of this disclosure, and FIG. 2 is a functional block diagram of the guaranteeing server of FIG. 1.

As shown in FIGS. 1 and 2, the guaranteeing server 1 is coupled to a blockchain network 4 and comprises a memory unit 11, one or more processing units 12, and one or more input/output units 13. In this embodiment, the guaranteeing server 1 comprises one processing unit 12 and one input/output unit 13. The memory unit 11 stores a plurality of instructions (e.g. program codes), and the processing unit 12 is coupled to the input/output unit 13 and the memory unit 11. The memory unit 11 may be a random memory or a non-volatile computer readable storage medium. The non-volatile computer readable storage medium is, for example, a hard disk, a solid state drive (SSD), a flash memory or the likes that stores instructions (e.g. program codes) executable by the processing unit 12. The processing unit 12 can be the core control member of the guaranteeing server 1, such as a CPU (central processing unit), or any of other control hardware, software or firmware. The processing unit 12 can load instructions (e.g. program codes) from a non-volatile computer readable storage medium to the random memory and execute the loaded instructions. The input/output unit 13 is, for example, a network card, a network chip, a modem, or the likes that can provide network connection.

In addition, the guaranteeing server 1 is also coupled to a user computing device 2 and a store computing device 3 by, for example but not limited to, wireless network or wired network. The user computing device 2 and the store computing device 3 can be mobile devices, notebook computers, desktop computers, devices with on-line function (e.g. smart home appliances or smart watches), or other computing devices. This disclosure is not limited.

As shown in FIG. 1, the blockchain network 4 includes a plurality of computers (or nodes), and the amount of the computers is not limited. To be noted, as shown in FIG. 1, the blockchain network 4 includes seven computers 41˜47. However, this is an illustration only, and is not to limit this disclosure. The user computing device 2 also connects to the blockchain network 4. For example, the user computing device 2 is connected to the computer 41 of the blockchain network 4 by wireless or wired connection, and then coupled to the entire blockchain network 4. Alternatively, the user computing device 2 can be one node of the blockchain network 4 and thus become a part of the blockchain network 4. Similarly, the store computing device 3 can also connect to the blockchain network 4. For example, the store computing device 3 is connected to the computer 46 of the blockchain network 4 by wireless or wired connection, and then coupled to the entire blockchain network 4. Alternatively, the store computing device 3 can be one node of the blockchain network 4 and thus become a part of the blockchain network 4. This disclosure is not limited thereto.

The processing unit 12 is configured to read and execute the instructions stored in the memory unit 11 to control the guaranteeing server 1 to perform following actions of: receiving a transaction data from a user (e.g. the user computing device 2), wherein the transaction data comprises a wallet data, which includes a wallet address data and a user's signature data (step S1); checking whether a cryptocurrency balance associated with the wallet address data on the blockchain network is sufficient to execute the transaction (step S2); when the cryptocurrency balance is sufficient to execute the transaction, transmitting the transaction data to the blockchain network for performing a blockchain operation (step S3); and transmitting a transaction guarantee information corresponding to the transaction data to an opposing party of the transaction (step S4).

To be noted, the sequence of the steps S3 and S4 is not limited. For example, the guaranteeing server 1 can transmit the transaction data to the blockchain network 4 in advance and then transmit the transaction guarantee information to the opposing party. Alternatively, the guaranteeing server 1 can transmit the transaction guarantee information to the opposing party in advance and then transmit the transaction data to the blockchain network 4. Otherwise, the guaranteeing server 1 can transmit the transaction guarantee information to the opposing party and transmit the transaction data to the blockchain network 4 simultaneously.

For example, when a user A orders a goods with a price of 0.5 ETH in a store C, the store C is the opposing party of the transaction. In this embodiment, the user A utilizes the user computing device 2 to initiate the transaction, and the store C utilizes the store computing device 3 to perform this transaction. In order to pay for the ordered goods, the user A can operate the user computing device 2 to issue a transaction application to the guaranteeing server 1 and transmit a transaction data corresponding to the transaction. In this case, the transmitted transaction data includes a wallet data of the user A, which is used for paying this transaction, the transaction content (i.e. 0.5 ETH), and the opposing party data of the transaction, which can be the name of the store C and/or the wallet address of the store C for receiving the paid 0.5 ETH. To be noted, in this embodiment, the used cryptocurrency can also be Bitcoin (BTC), Bitcoin cash (BCC), Litecoin (LTC) or Monero (XMR), or any of other digital currencies (e.g. virtual currency), and this disclosure is not limited.

The above-mentioned wallet data further contains a wallet address data providing the cryptocurrency for this transaction and a user's signature data. The wallet address data indicates the wallet address for paying 0.5 ETH (to be paid by the user A), and the user's signature data includes the digital signature of the user A associated with the transaction. The above-mentioned wallet address data is generated by a computer, which performs the above-mentioned elliptic curve calculation, hash function calculation and encoding based on a private key of the user A and/or a private key of the guaranteeing server 1. The computer can be, for example, the user computing device 2, the guaranteeing server 1, or other third-party computing devices, and this disclosure is not limited thereto. In addition, the aforementioned user's signature data (i.e. the digital signature of the user A for the transaction) is also generated by the user computing device 2 after performing asymmetric encryption or the likes using the private key of the user A. Moreover, since this embodiment is constructed by means of a smart contract, the transaction data transmitted from the user computing device 2 to the guaranteeing server 1 may further include the address data for executing the smart contract on the blockchain network 4, so that each node of the blockchain network 4 can perform the subsequent verification.

If the user's private key is not transmitted to the guaranteeing server 1 based on security considerations, the user computing device 2 can directly utilize the private key of the user A to perform the elliptic curve calculation, hash function calculation, and encoding when the wallet address corresponding to the transaction is generated,.

After the guaranteeing server 1 receives the transaction data (step S1), it queries the nodes 41 to 47 of the blockchain network 4 (in the blockchain record) to check that whether a cryptocurrency balance associated with the wallet address record in the wallet address data is sufficient to execute the transaction (step S2). That is, the guaranteeing server 1 will query through each node and confirm that there is enough credit in the wallet address to pay for 0.5 ETH of this transaction. The input/output unit 13 of the guaranteeing server 1 is configured to receive the transaction data.

When the guaranteeing server 1 confirms that there is a sufficient amount in the wallet address to pay the 0.5 ETH, the guaranteeing server 1 will send a transaction guarantee information corresponding to the transaction to the store computing device 3 of the store C (step S4), which represents that the wallet address of the user A has enough credit for paying the 0.5 ETH for the transaction. At this point, the store C can quickly know that the transaction has been authenticated and guaranteed by the guaranteeing server 1, thereby conforming the validity of the transaction and eliminating the need to wait for several times of confirmations (e.g., six times of confirmations) from the blockchain network 4. In addition, in a preferred embodiment, the guaranteeing server 1 can further transmit the transaction guarantee information to the user computing device 2 (the user A) to notify the user A that the transaction has been guaranteed by the guaranteeing server 1, thereby also eliminating the need of the user A to wait for several times of confirmations (e.g., six times of confirmations) from the blockchain network 4.

In addition, the guaranteeing server 1 transmits the transaction data corresponding to the transaction to the blockchain network 4, and the nodes 41 to 47 perform corresponding blockchain operations such as authentication and recording (step S3). The transaction data transmitted to the blockchain network 4 comprises the wallet address data, the transaction content data, the opposing party data of the transaction, the user's signature data, and the address data of the smart contract uploaded from the user computing device 2. Accordingly, after receiving the transaction data transmitted from the guaranteeing server 1, each of the nodes 41 to 47 of the blockchain network 4 can perform the authentication according to the user's signature data and the wallet address in the transaction data as well as the address of the smart contract.

In detailed, each of the nodes 41 to 47 decrypts the user's digital signature data by using the public key corresponding to the wallet address and then conduct the authentications. Only after confirming that the digital signature data of the user's digital signature data are true, the payment function of the transaction is executed according to the smart contract, and the transaction content data and the opposing party data are encrypted and encoded so as to concatenate (i.e. record) it as a new block on the existing blockchain, thereby completing the transaction. Then, the user A has paid the 0.5 ETH from the user's wallet to the opposing party (i.e. the store C). In addition, when recording the transaction content, each of the nodes 41-47 can also incorporate the time stamp corresponding to the transaction into the new block, so that the newly added block content is difficult to be tampered with and becomes verifiable and traceable.

In some embodiments, after finishing the blockchain operation, the guaranteeing server 1 further returns the operation result (a transaction success conformation information) to the user A and/or the opposing party (the store C) for acknowledging the user A and/or the opposing party (the store C) that the transaction has been done and confirmed. In some embodiments, after finishing the blockchain operation, the guaranteeing server 1 further summarizes the cryptocurrency balance associated with the wallet address data of the user A. Herein, the “summarize” step is to transfer 0.5 ETH from the wallet of the user A to the wallet of the store C. In other words, the wallet of the user A reduces 0.5 ETH, and the wallet of the store C adds 0.5 ETH. To be noted, in some embodiments, the store C does not need to withdraw the corresponding cryptocurrency after each transaction. For example, the store C may withdraw the cryptocurrency after multiple transactions or a period of time (e.g. 1 day). This operation can reduce the operation frequency of the store computing device 3 and/or the guaranteeing server 1 so as to decrease the entire cost.

In some embodiments, when the guaranteeing server 1 finds that the cryptocurrency balance of the wallet address is not enough to pay 0.5 ETH for the transaction, the guaranteeing server 1 will send a transaction fail information to the user A (the user computing device 2) to announce the user A that the assigned wallet does not have enough cryptocurrency for finishing this transaction. Thus, the user A can take some actions to maintain and valid this transaction. For example, the user A may add sufficient cryptocurrency to the wallet address, or assign another wallet address having enough cryptocurrency for this transaction. Meanwhile, the guaranteeing server 1 does not transmit the transaction data to the blockchain network 4 for authentication and recording. Moreover, the guaranteeing server 1 can also send the transaction fail information to the store computing device 3 for announcing the opposing party that this transaction is not finished yet.

As mentioned above, when the guaranteeing server 1 finds that the cryptocurrency balance of the wallet address is not enough to pay 0.5 ETH for the transaction and sends the transaction fail information to announce the user A that the assigned wallet does not have enough cryptocurrency for finishing this transaction, the user A can add sufficient cryptocurrency to the wallet address (deposit to the wallet) by, for example but not limited to, the following three methods.

In the first method, the user A can transmit the wallet data and a deposit data (including the deposited cryptocurrency amount) to the blockchain network 4 through the user computing device 2 for increasing the cryptocurrency balance corresponding to the wallet address data through the blockchain network 4 (the user A pays Gas). Afterwards, the step S2 is performed again to check whether the cryptocurrency balance associated with the wallet address data is sufficient to execute the transaction by the guaranteeing server 1.

In the second method, the store C can transmit the wallet data and the deposit data (including the deposited cryptocurrency amount) to the blockchain network 4 through the store computing device 3 for increasing the cryptocurrency balance corresponding to the wallet address data of the user A through the blockchain network 4. In this case, the user A may pay cash corresponding to 0.5 ETH to the store C, and then the store C can deposit the wallet on blockchain network 4 (the store C pays Gas). To be noted, in other embodiments, the user A and/or the store C can finishing the depositing operation through the guaranteeing server 1, and this disclosure is not limited thereto.

In the third method, the user A can assign another wallet address having enough cryptocurrency balance for performing this transaction. For example, the user A can send another wallet data, a deposit data and the wallet data of the user A to the guaranteeing server 1 for increasing the cryptocurrency balance associated with the wallet address data of the user A through the guaranteeing server 1. Herein, the another wallet data can be another wallet of the user A or a wallet of another user B. In this case, the guaranteeing server 1 is configured to record, and neither A nor B has to pay Gas.

To be noted, the above three methods for adding sufficient cryptocurrency to the wallet address of the user A are not limited to the transaction failure case and can also be applied in a general depositing operation.

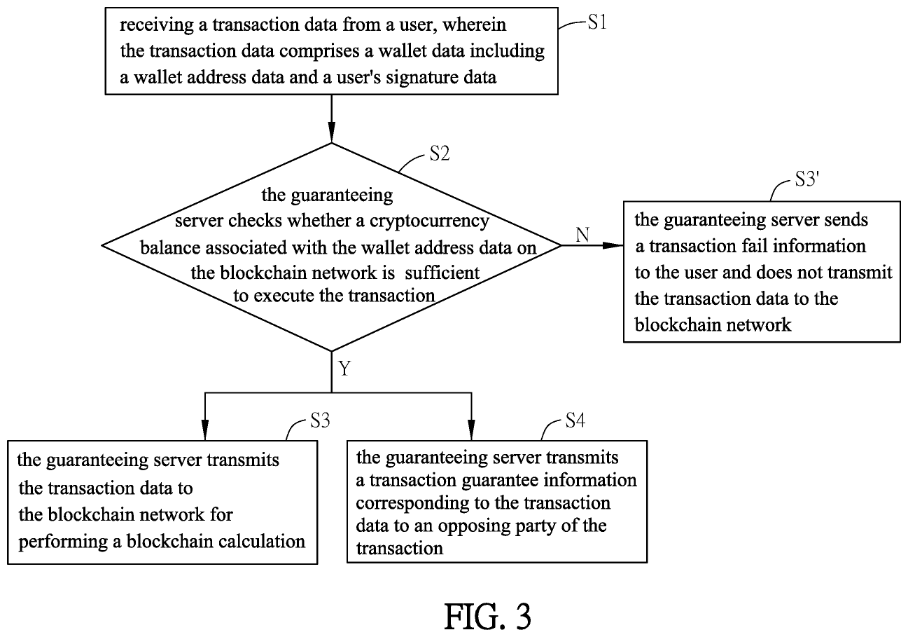

In addition, this disclosure also provides a guaranteeing method for a transaction on blockchain, which is applied to the above-mentioned guaranteeing server 1 and the blockchain network 4. FIG. 3 is a flow chart of a guaranteeing method for transactions on blockchain according to an embodiment of this disclosure. As shown in FIG. 3, the guaranteeing method for transactions on blockchain comprises the following steps S1 to S4.

The step S1 is to receive a transaction data from a user A by a guaranteeing server 1, wherein the transaction data comprises a wallet data including a wallet address data and a user's signature data. In the step S2, the guaranteeing server 1 checks whether a cryptocurrency balance associated with the wallet address data on the blockchain network 4 is sufficient to execute the transaction. In the step S3, when the cryptocurrency balance is sufficient to execute the transaction, the guaranteeing server 1 transmits the transaction data to the blockchain network 4 for performing a blockchain operation. In the step S4, the guaranteeing server 1 transmits a transaction guarantee information corresponding to the transaction data to an opposing party of the transaction. The sequence of the steps S3 and S4 is not limited. That is, the steps S3 and S4 can be switched or performed simultaneously. In addition, when the cryptocurrency balance is not enough to execute the transaction, the guaranteeing server 1 sends a transaction fail information to the user and does not transmit the transaction data to the blockchain network 4 (step S3′).

The detailed components of the guaranteeing server 1, the user computing device 2, the store computing device 3 and the blockchain network 4, the modifications of the guaranteeing method, and the connections of the guaranteeing server 1, the user computing device 2, the store computing device 3 and the blockchain network 4 can be referred to the above embodiment, so the detailed descriptions thereof will be omitted.

In summary, the disclosed guaranteeing server 1 and guaranteeing method can check whether a cryptocurrency balance of the user is sufficient to execute the transaction before transmitting the transaction to the blockchain network 4 for operation, thereby preventing the double spend attack from malicious users. In addition, after confirming that the cryptocurrency balance of the user is sufficient to execute the transaction, the guaranteeing server 1 can transmit the transaction guarantee information to the opposing party of the transaction. Based on the authentication and guaranteeing from the guaranteeing server, the opposing party can be acknowledged whether the transaction is guaranteed by the guaranteeing server 1 or not within a short time, thereby guaranteeing the validity of the transaction and reducing the waiting time.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A guaranteeing server for a transaction on blockchain, the guaranteeing server coupled to a blockchain network and comprising a memory unit and one or more processing units, the memory unit storing a plurality of instructions, and the processing units executing the instructions to perform steps of:
receiving a transaction data from a user, wherein the transaction data comprises a wallet data including a wallet address data and a user's signature data;
checking whether a cryptocurrency balance associated with the wallet address data on the blockchain network is sufficient to execute the transaction;
when the cryptocurrency balance is sufficient to execute the transaction, transmitting the transaction data to the blockchain network for performing a blockchain operation; and
transmitting a transaction guarantee information corresponding to the transaction data to an opposing party of the transaction.

2. The guaranteeing server of claim 1, wherein the user's signature data is a digital signature of the user corresponding to the wallet address data.

3. The guaranteeing server of claim 1, wherein the transaction data further comprises a transaction content and an opposing party data.

4. The guaranteeing server of claim 1, wherein when the cryptocurrency balance is not enough to execute the transaction, the guaranteeing server sends a transaction fail information to the user and does not transmit the transaction data to the blockchain network.

5. The guaranteeing server of claim 1, wherein the user uploads the wallet data and a deposit data to the blockchain network for increasing the cryptocurrency balance associated with the wallet address data through the blockchain network.

6. The guaranteeing server of claim 1, wherein the opposing party uploads the wallet data and a deposit data to the blockchain network for increasing the cryptocurrency balance associated with the wallet address data through the blockchain network.

7. The guaranteeing server of claim 1, wherein the user sends another wallet data, a deposit data and the wallet data to the guaranteeing server for increasing the cryptocurrency balance associated with the wallet address data through the guaranteeing server.

8. The guaranteeing server of claim 1, wherein after finishing the blockchain operation, the guaranteeing server further returns a transaction success conformation information to the user and/or the opposing party.

9. The guaranteeing server of claim 1, wherein after finishing the blockchain operation, the guaranteeing server further summarizes the cryptocurrency balance associated with the wallet address data.

10. A guaranteeing method for a transaction on blockchain, comprising steps of:
receiving a transaction data from a user by a guaranteeing server, wherein the transaction data comprises a wallet data including a wallet address data and a user's signature data;
the guaranteeing server checking whether a cryptocurrency balance associated with the wallet address data on the blockchain network is sufficient to execute the transaction;
when the cryptocurrency balance is sufficient to execute the transaction, the guaranteeing server transmitting the transaction data to the blockchain network for performing a blockchain operation; and
the guaranteeing server transmitting a transaction guarantee information corresponding to the transaction data to an opposing party of the transaction.

11. The guaranteeing method of claim 10, wherein the user's signature data is a digital signature of the user corresponding to the wallet address data.

12. The guaranteeing method of claim 10, wherein the transaction data further comprises a transaction content and an opposing party data.

13. The guaranteeing method of claim 10, wherein when the cryptocurrency balance is not enough to execute the transaction, the guaranteeing server sends a transaction fail information to the user and does not transmit the transaction data to the blockchain network.

14. The guaranteeing method of claim 10, wherein the user uploads the wallet data and a deposit data to the blockchain network for increasing the cryptocurrency balance associated with the wallet address data through the blockchain network.

15. The guaranteeing method of claim 10, wherein the opposing party uploads the wallet data and a deposit data to the blockchain network for increasing the cryptocurrency balance associated with the wallet address data through the blockchain network.

16. The guaranteeing method of claim 10, wherein the user sends another wallet data, a deposit data and the wallet data to the guaranteeing server for increasing the cryptocurrency balance associated with the wallet address data through the guaranteeing server.

17. The guaranteeing method of claim 10, wherein after finishing the blockchain operation, the guaranteeing server further returns a transaction success conformation information to the user and/or the opposing party.

18. The guaranteeing method of claim 10, wherein after finishing the blockchain operation, the guaranteeing server further summarizes the cryptocurrency balance associated with the wallet address data.
